(19) United States
(12) Patent Application Publication
(10) Pub. No.: US 2023/0240807 A1
(43) Pub. Date: Aug. 3, 2023

(54) ORTHODONTIC BRACKET AND BRACKET SUPPORT SYSTEM AND METHOD

(71) Applicant: SprintRay Inc., Los Angeles, CA (US)

(72) Inventors: Mark Lorich, Los Angeles, CA (US); Amir Gordji, Los Angeles, CA (US)

(21) Appl. No.: 18/088,472

(22) Filed: Dec. 23, 2022

Related U.S. Application Data
(60) Provisional application No. 63/296,605, filed on Jan. 5, 2022.

(51) Int. Cl. A61C 7/14; A61C 7/16; A61C 7/20; A61C 7/00

(52) U.S. Cl. CPC A61C 7/146; A61C 7/002; A61C 7/16; A61C 7/20

(57) ABSTRACT

An orthodontic bracket and bracket support system, and its method of manufacture and use is provided. The system includes a bracket assembly including one or more bracket members to be bonded to a patient’s teeth, a placement guide assembly including one or more placement members to properly position the bracket members for the bonding procedure, and a support assembly to support the bracket assembly and/or the placement guide assembly during manufacture and use. The bracket assembly, the placement guide assembly, and the support assembly are formed together and in combination using stereolithography three-dimensional (3D) printing.

### FIELD OF THE INVENTION

This invention relates to orthodontics, including an orthodontic bracket and bracket support system and the method of its manufacture and use.

### BACKGROUND

During orthodontic teeth straightening procedures, brackets are bonded to the front surfaces of the teeth and subsequently attached to an archwire that is then used to apply force to the brackets to move the teeth.

Until somewhat recently, the brackets were traditionally placed and bonded one-by-one to each respective tooth by hand. Accordingly, the procedure was often time consuming.

To improve this procedure and to reduce each patient’s chair time, indirect bonding trays (IBTs) were developed that allow for multiple brackets to be positioned and bonded simultaneously. The IBTs comprise trays formed using the patient’s teeth impressions and include individual slots designed to hold each bracket in its proper position for the procedure. The trays (and the included brackets) are placed on the patient’s teeth and the brackets are bonded.

However, creating IBTs can be an expensive process. For example, traditional IBTs require a dedicated thermoforming machine and a dedicated compressed air hookup to create the IBTs. In addition, use of this machine is very loud.

Additionally, using IBTs can be a tedious process, requiring multiple manual steps, e.g., forming the IBT, placing each bracket into its slot within the tray, etc. This leaves room for human error which may lead to mistakes and problems with the procedure.

Accordingly, there is a need for an orthodontic bracket and bracket support system that may be manufactured as a single unit.

### SUMMARY

According to one aspect, one or more embodiments are provided below for an orthodontic bracket and bracket support system and its method of manufacture and use.

One aspect of the invention involves a method of manufacturing an orthodontic bracket system. In exemplary embodiments, the method may include: receiving, by one or more computer systems, a digital impression of a patient’s tooth; receiving, by the one or more computer systems, a digital model of an orthodontic bracket; positioning, by the one or more computer systems, the digital model of the orthodontic bracket onto the digital impression of the patient’s tooth; forming, by the one or more computer systems, a digital model of a placement member including at least one support contour that matches at least one contour of the digital model of the patient’s tooth; placing, by the one or more computer systems, the at least one support contour of the placement member digital model onto the at least one matching contour of the digital impression of the patient’s tooth; forming, by the one or more computer systems, a digital model of a base member; forming, by the one or more computer systems, a digital model of a support member, the digital model of the support member extending between the digital model of the base member and the digital model of the orthodontic bracket and/or between the digital model of the base member and the digital model of the placement member; and printing, using a three-dimensional printer, the digital model of the orthodontic bracket, the digital model of the placement member, the digital model of the base member, and the digital model of the support member to form a physical orthodontic bracket system; wherein the physical orthodontic bracket system includes an orthodontic bracket, a placement member, a base member, and a support member as a single unit.

In some exemplary embodiments, the printing of the digital model of the orthodontic bracket, the digital model of the placement member, the digital model of the base member, and the digital model of the support member includes combining the digital model of the orthodontic bracket, the digital model of the placement member, the digital model of the base member, and the digital model of the support member into a single printable file.

In some exemplary embodiments, the forming of the digital model of the placement member further comprises forming a digital shell, by the one or more computer systems.

In some exemplary embodiments, the forming of the digital model of the placement member further includes isolating, by the one or more computer systems, a lower portion of the digital impression of the patient’s tooth; hollowing, by the one or more computer systems, the isolated lower portion of the digital impression of the patient’s tooth to form a digital shell.

In some exemplary embodiments, the method may further include forming, by the one or more computer systems, sidewalls of a desired thickness of the digital shell.

In some exemplary embodiments, an inner surface of the digital shell includes the at least one support contour. In some exemplary embodiments, the placing of the at least one support contour of the placement member digital model onto the at least one matching contour of the digital impression of the patient’s tooth includes placing the digital shell onto the lower portion of the digital impression of the patient’s tooth.

In some exemplary embodiments, the method may further include: applying a bonding agent to a back side of the orthodontic bracket; placing the placement member onto the patient’s tooth; wherein placing the placement member onto the patient’s tooth places the back side of the orthodontic bracket onto a front surface of the patient’s tooth.

In some exemplary embodiments, the method may further include: disconnecting the support member from the orthodontic bracket.

Another aspect of the invention involves an orthodontic bracket system. In exemplary embodiments, the system may include: a bracket member adapted to be coupled to a surface of a tooth and to receive a tooth straightening mechanism; a placement member adapted to contact at least one surface of the tooth; a base member; a support member configured between the base member and the bracket member and/or between the base member and the placement member.

In some exemplary embodiments, the placement member includes a shell including an inner volume adapted to receive a bottom portion of the tooth.

In some exemplary embodiments, wherein the shell inner volume is defined by inner sidewalls and wherein the inner sidewalls include at least one inner sidewall contour that matches a contour of the at least one surface of the tooth.

In some exemplary embodiments, the support member includes at least one elongate post. In some exemplary embodiments, the at least one elongate post includes a tapered distal tip. In some exemplary embodiments, the tapered distal tip is at an offset angle with respect to the at least one elongate post. In some exemplary embodiments, the base member is located below the bracket member and/or below the placement member. In some exemplary embodiments, the tooth straightening mechanism includes an archwire.

The presently disclosed orthodontic bracket and bracket support system and its method of manufacture and use is more fully described in the detailed description below.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification. None of the drawings are to scale unless specifically stated otherwise.

FIG. 1 shows a front view of an orthodontic bracket and bracket support system in accordance with exemplary embodiments hereof;

FIGS. 2A-2C show aspects of an orthodontic bracket in accordance with exemplary embodiments hereof;

FIGS. 3A-3B show aspects of a bracket assembly and a placement guide assembly in accordance with exemplary embodiments hereof;

FIG. 4 shows aspects of a bracket assembly, a placement guide assembly, and a support assembly in accordance with exemplary embodiments hereof;

FIG. 5 shows aspects of an orthodontic bracket and bracket support system in accordance with exemplary embodiments hereof;

FIGS. 6A-6C show results of actions taken during the design of a placement member in accordance with exemplary embodiments hereof; and

FIG. 7 shows actions taken to design, manufacture, and implement an orthodontic bracket and bracket support system in accordance with exemplary embodiments hereof.

### DETAILED DESCRIPTION OF EXEMPLARY EMBODIMENTS

In general, the system and method according to exemplary embodiments hereof includes an orthodontic bracket and bracket support system and method of manufacture and use. The system includes one or more orthodontic brackets held in position by one or more placement members. The placement members are designed to engage each particular tooth and to hold a corresponding bracket at the proper location and orientation for the bonding of the bracket to the tooth.

As will be described herein, in some embodiments, the system may be manufactured as a single unit (e.g., using a 3D printer) thereby saving cost, time, and money.

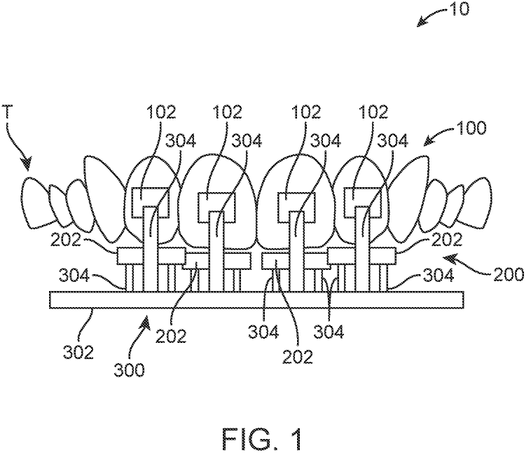

In one exemplary embodiment hereof, as shown in FIG. 1, the orthodontic bracket and bracket support system 10 (also referred to herein as simply the system 10) includes an orthodontic bracket assembly 100, a placement guide assembly 200, and a support assembly 300. In general, the bracket assembly 100 includes one or more orthodontic bracket members 102, with each bracket member 102 designed to be bonded to a corresponding tooth T during a teeth straightening procedure. The placement guide assembly 200 includes one or more placement members 202, with each placement member 202 corresponding to a particular bracket member(s) 102. During the bracket bonding procedure, the placement guide assembly 200 is used to properly position each bracket member 102 on its corresponding tooth T. The bracket assembly 100 and the placement guide assembly 200 are supported during manufacturing and/or during use by the support assembly 300. The system 10 also may include other elements as necessary for the system 10 to perform its functionalities as described herein or otherwise.

As will be described herein, in some embodiments, the bracket assembly 100, the placement guide assembly 200, and the support assembly 300 are formed together (preferably in combination) using three-dimensional (3D) printing (e.g., using a stereolithography 3D printer and/or other type of 3D printer).

The assemblies 100, 200, 300 are represented in FIG. 1 as blocks to provide a general understanding of the general placement and functionalities of the assemblies 100, 200, 300. However, it is understood that this depiction of the assemblies 100, 200, 300 is not meant to necessarily represent the sizes, shapes, orientations, and/or other aspects of the assemblies 100, 200, 300 and that FIG. 1 does not limit the scope of the system 10 and/or of the assemblies 100, 200, 300 in any way.

In addition, while the system 10 is shown in FIG. 1 as configured with the right and left central and lateral incisors of the illustrated teeth T, it is understood that the system 10 may be configured with any teeth T, and that the system 10 is not limited in any way by the teeth T with which it may be configured.

### Bracket Assembly 100

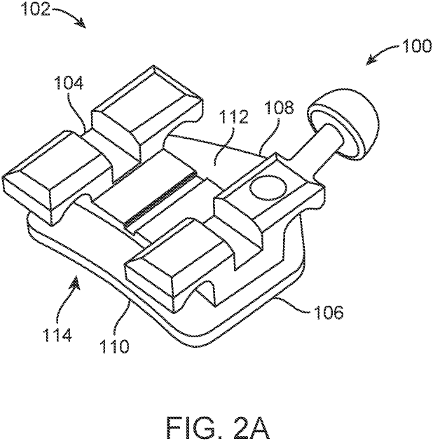

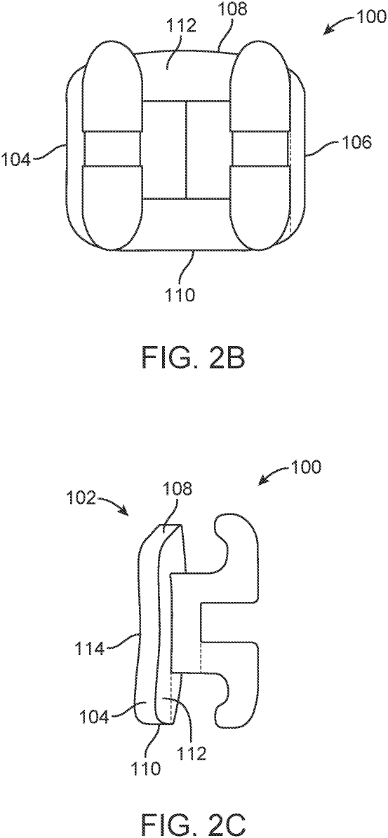

In some embodiments, as shown in FIGS. 2A-2C, the bracket assembly 100 includes one or more bracket members 102. Each bracket member 102 includes a left side 104, a right side 106, a top side 108, a bottom side 110, a front side 112, and a back side 114. In general, the back side 114 is designed to be bonded to the front surface of a corresponding tooth T, and the front side 112 is designed to be configured with a corresponding portion of an archwire via one or more tie-wings and ligatures to provide the mechanisms for the teeth straightening procedure.

It is understood that the bracket member 102 shown in FIG. 2 is generic in nature and is meant for demonstration. It also is understood that other types of bracket members 102 may be used and that the scope of the system 10 is not limited in any way by the type(s) of bracket members 102 employed by the system 10.

As will be described in other sections, the bracket members 102 are configured with the placement guide assembly 200 and the support assembly 300 to facilitate the bonding of the members 102 to the corresponding teeth T.

### Placement Guide Assembly 200

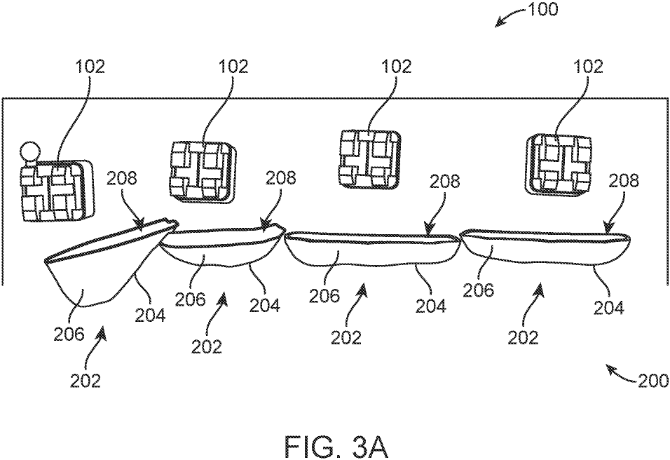

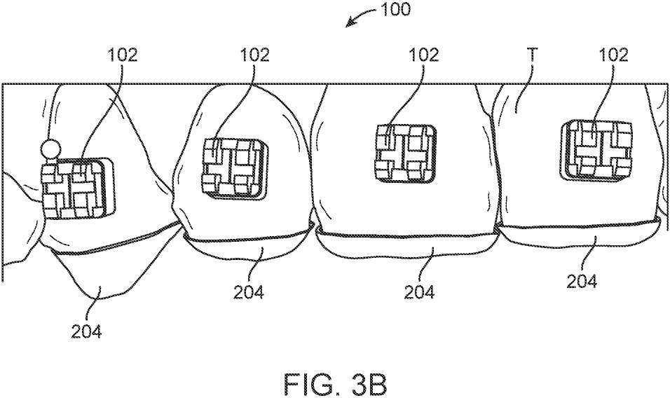

In some embodiments, as shown in FIGS. 3A-3B, the placement guide assembly 200 includes one or more placement members 202. Each placement member 202 is designed to engage a particular tooth T to facilitate the alignment and positioning of a corresponding bracket member 102. Accordingly, in some embodiments, there may be a one-to-one correlation between each placement member 202 and a corresponding bracket member 102.

In some embodiments, each placement member 202 is designed to engage a portion of a particular tooth T (e.g., the lower portion) of a particular patient. In this way, the placement members 202 may be customized for each patient.

For example, in some embodiments, as shown in FIG. 3A, a placement member 202 may include a shell member 204 including sidewalls 206 defining an inner volume 208. In some embodiments, the sidewalls 206 and inner volume 208 of each shell member 204 are contoured to generally match the contours and shape of a corresponding portion of a tooth T that the shell member 204 may be designed to engage. In this way, as shown in FIG. 3B, each shell member 204 may receive and custom-fit a portion (e.g., the lower portion) of its corresponding tooth T. Once engaged, it may be preferable that each shell member 104 be generally held in place by the junction between the tooth T and the sidewalls 206 of the respective member 204 (e.g., by pressure fit, suction, and/or friction given their matching contours and shape). In this way, each shell member 204 may provide a stationary reference position for each corresponding bracket member 102 as will be described in other sections.

In some embodiments, the sidewalls 206 may extend about the entire circumference of a particular tooth T as shown in FIG. 3B (with the shell member 204 generally capping the lower portion of the tooth T). However, in other embodiments, the sidewalls 206 may extend about one or more circumferential portions of a particular tooth T (e.g., there may be gaps in the sidewalls 206). It also is contemplated that the placement members 202 include other types of forms (not necessarily shell-like) such as, without limitation, rings, U-shaped members, V-shaped members, cones, cylinders, other suitable forms, and any combinations thereof.

### Support Structure Assembly 300

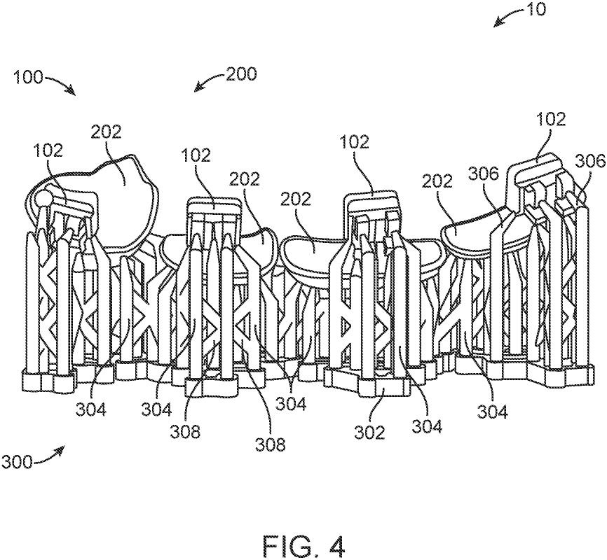

In some embodiments, as shown in FIG. 4, the support assembly 300 includes one or more bases 302 configured with one or more support members 304. In some embodiments, each support member 304 generally extends between a base 302 and a bracket member 102 and/or between a base 302 and a placement member 202 thereby providing support thereto.

In some embodiments, as shown in FIG. 4, the support members 304 are elongate with a proximal end coupled to a base 302 and a distal end coupled to a bracket member 102 and/or to a placement member 202. In these embodiments, the support members 304 may be referred to as support arms.

In some embodiments, the distal end of a support member 304 may include a tip 306 designed to be attached to a bracket member 102 and/or to a placement member 202. In some embodiments, the tip 306 extends away from the body of the support member 304 at an offset angle relative to the support member body (e.g., at 0°-180° and preferably about 90°-180°, and more preferably about 110°-170°). This may allow for a plurality of support members 304 to be utilized in a small working area and for the bracket members 102 and/or the placement members 202 to be held offset from the support member bodies to avoid obstruction.

In some embodiments, the diameter of a tip 306 may taper from a larger diameter at the support member body to a smaller diameter at the junction between the tip 306 and the bracket member 102 and/or the placement member 202.

In some embodiments, the support members 304 (e.g., the tips 306) may attach to a front side 112 of a bracket member 102 as shown. In some embodiments, it may be preferable for the support members 304 or tips 306 to not obstruct critical areas of the bracket member 102 such as the archwire slots, tie-wings, and/or other parts of the bracket member 102 that may not be easily post-processed. However, it is understood that a support member 304 (e.g., a tip 306) may be attached to any surface of a bracket member 102, including, but not limited to, the left side 104, the right side 106, the top side 108, the bottom side 110, the front side 112, any other side, and any combinations thereof. It also is understood that a support member 304 (e.g., a tip 306) may be attached to any surface of a placement member 202 (e.g., to any portion of a shell member’s sidewall 206). It is also understood that any number of support members 302 may be used to support a bracket member 102 and/or a placement member 202. In some exemplary embodiments, there may be a desire to avoid placement of supports in particular areas. For example, and without limiting the scope of the present invention, on placement member 202, the “inside” surface that comes in direct contact with the lower part of the tooth, it may be desirable to avoid placing support tips 306. Additionally on bracket member 102, the “inside” surface which comes in direct contact with the front face of the tooth, it may be desirable to avoid placing support tips 306 there as well. This is because if support tips 306 are placed in these 2 areas, the invention may not function without the user removing support tips 306. Doing so may cause unnecessary work, and may also negatively impact the desired fit of these surfaces to the teeth. As a result of this, there are limitations to how many teeth can be printed in groupings. A setup of too many teeth may force supports to be placed in undesirable locations, so we typically will print groups of 3-4 teeth as seen in FIG. 4.

In some embodiments, the support assembly 300 includes support beams 308 extending between two or more support members 304 to provide additional support to the members 304. In this way, the support members 304 and support beams 308 may generally form a lattice structure. While FIG. 4 shows the support beams 308 as generally cross-shaped beams, any form of support beams may be used. In addition, the support beams 308 also may extend from a support member 304 to a base 302.

In some embodiments, software (e.g., 3D printing software and/or CAD software) may be used to model the layout of the support members 304 and/or support beams 308 and to automatically place the modeled support members 304 and/or support beams 308 in their proper locations within the modeled layout. In addition, the user may then choose to add, move, remove, and/or replace the modeled support members 304 and/or the modeled support beams 308 as desired (e.g., to remove potential obstructions).

In some embodiments, the support members 304 are not necessarily elongate structures. For example, in some embodiments, the support members 304 include walls that extend from a base 302 to one or more bracket members 102 and/or to one or more placement members 202. Other shaped structures also may be used, such as, without limitation, cylinders, cones, and/or other suitably formed structures.

In some embodiments, as shown in FIG. 4, the one or more bases 302 are generally located below the bracket assembly 100 and/or the placement guide assembly 200, with the support members 304 extending generally upward from the one or more bases 302 to the assemblies 100, 200. However, it also is contemplated that the one or more bases 302 may be positioned in any location relative to the bracket assembly 100 and/or relative to the placement guide assembly 200. For example, the one or more bases 302 may be positioned generally in front of the assemblies 100, 200, to the left and/or right of the assemblies 100, 200, in any other positions relative to the assemblies 100, 200, and in any combinations thereof.

In some embodiments, a support member 304 may extend directly from a placement member 202 to a bracket member 102 (without connecting to a base 302). For example, in some embodiments, a support member 304 may extend from a side of a placement member 202 to the front 112 or bottom 110 of a bracket member 102. In this case, the support member 304 may include a curvature (one or more bends) so that the corresponding bracket member 102 is held in the proper position relative to the placement member 202 (e.g., the support member 304 may be J- or C-shaped). In this embodiment, it may be preferable that adjacent placement members 202 be connected to one another to provide support to the members 202 due to the absence of a base 302.

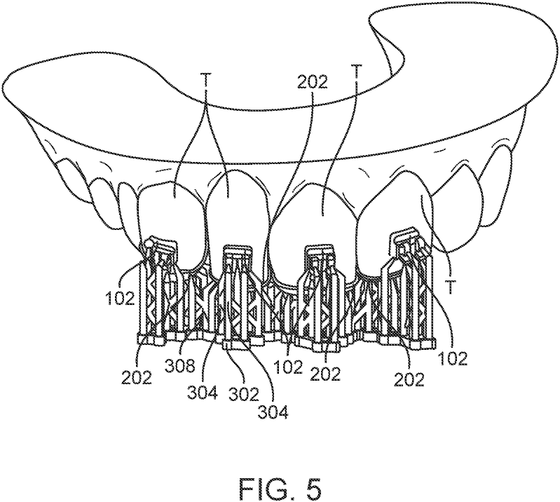

FIG. 5 shows the system 10 configured with a teeth model for demonstration. As shown, the lower portions (the lower tips) of the teeth T are each held within a corresponding placement member 202 (e.g., a custom shell member 204), and the bracket members 102 are each held in position against a corresponding tooth T by the support members 304 extending from the base 302. The placement members 202 also are held by support members 304 extending from the base 302. In this way, during an actual bracket bonding procedure, the system 10 may be placed in contact with the patient’s teeth (as described herein) thereby placing all of the bracket members 102 in the proper locations simultaneously for bonding.

In some embodiments, after the bonding process is completed, the support members 304 may be removed (e.g., cut or torn) from the bracket members 102 leaving only the bracket members 102 bonded to the teeth T. That is, placement guide assembly 200 is removed with support structure assembly 300, so that only the bracket members are left bonded to the teeth of the patient.

### Manufacturing the System 10

In some embodiments, the system 10 is manufactured using a 3D printer, e.g., using a stereolithography 3D printer or other type of 3D printer. That is, the system 10 may be 3D printed. In this way, the bracket assembly 100, the placement guide assembly 200, and the support assembly 300 are produced in combination as a single unit.

In some embodiments, computer aided design (CAD) files are generated for the system 10 and the CAD files are used to perform the 3D printing.

In some embodiments, CAD files are generated for the bracket assembly 100, the placement guide assembly 200, and the support assembly 300, and the respective CAD files for each assembly 100, 200, 300 are combined into a single CAD file used to perform the 3D printing of the system 10.

In some embodiments, CAD files for each bracket member 102 may be obtained, e.g., from a manufacturer of bracket members 102, from a scan, using CAD software (e.g., to customize the bracket members 102), or otherwise generated. The CAD files for the placement members 202 on the other hand, are preferably determined and generated custom for each individual patient.

In some embodiments, to begin the process, an orthodontic treatment plan is generated to determine the proper placement of the bracket members 102 for a particular patient. In some embodiments, the treatment plan may be generated using orthodontic treatment planning software (e.g., orthodontic CAD software). To generate the treatment plan, an impression (preferably digital) is taken of the patient’s teeth (e.g., using a 3D intraoral scanning system). The digital impression is then used by the orthodontic CAD software to determine the proper placement and position of each bracket member 102 on each corresponding tooth T, and the results (including each bracket member 102 and its respective position) are stored as digital CAD files. In addition, each bracket member 102 may include a custom back side 114 that follows the specific geometry of its corresponding tooth T. It is understood that other methods also may be used to generate an impression of the patient’s teeth and to enter the impression into the orthodontic CAD software.

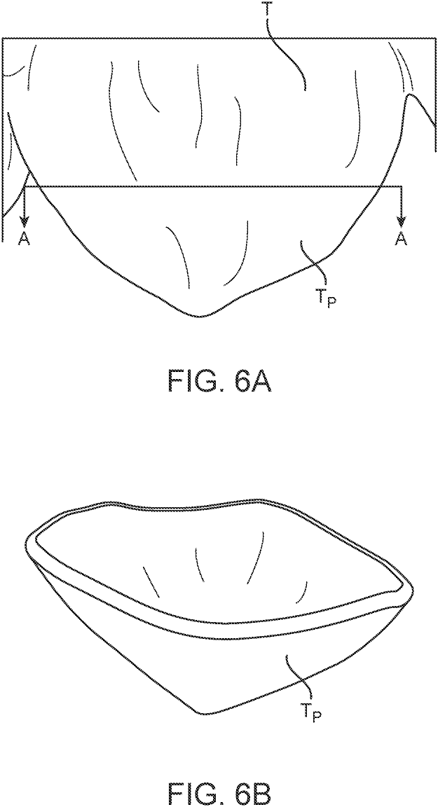

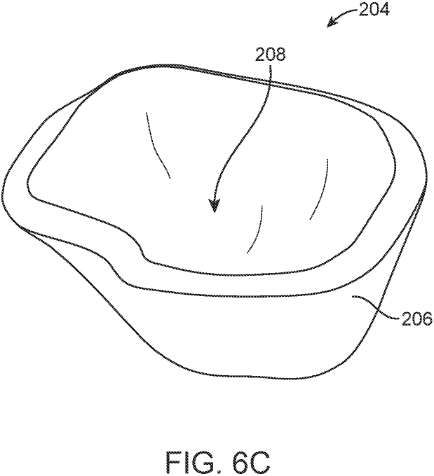

In some embodiments, each placement member 202 is designed using respective impressions of the patient’s teeth T. For example, in some embodiments, as shown in FIGS. 6A-6B, the CAD software is first used to isolate a lower portion T_{P} of a respective particular tooth T (e.g., at cut-fines A-A in FIG. 6A) and to create a new CAD file of the isolated portion (the lower portion of the tooth T shown in FIG. 6B).

Next, as shown in FIG. 6C, the CAD software is used to convert the solid isolated portion into a hollow shell including a desired wall thickness. This generally forms a CAD file that represents a respective shell member 204 for the particular tooth T as described in other sections. Because the shell member 204 is formed using the impression of the tooth T, the geometry of the shell’s inner volume 208 matches the outer geometry of the lower tooth portion T_{P}, thereby optimizing the custom fit.

This process may be repeated for each particular tooth T and corresponding shell member 204. The CAD files for each shell member 204 are then combined with the CAD files for each corresponding bracket member 102 to form a single CAD file that includes each desired member 102, 204 and their relative positionings with one another. An example of this is shown in FIG. 3A.

Next, the system 10 may determine the forms and layouts of the associated support members 304 and tips 306, base members 302, and/or support beams 308 to hold and support the shell members 204 and/or bracket members 102 in the proper locations and/or orientations to be implemented onto the patient’s teeth T as determined and as described in other sections.

In some embodiments, the combined file is then used to 3D print the system 10.

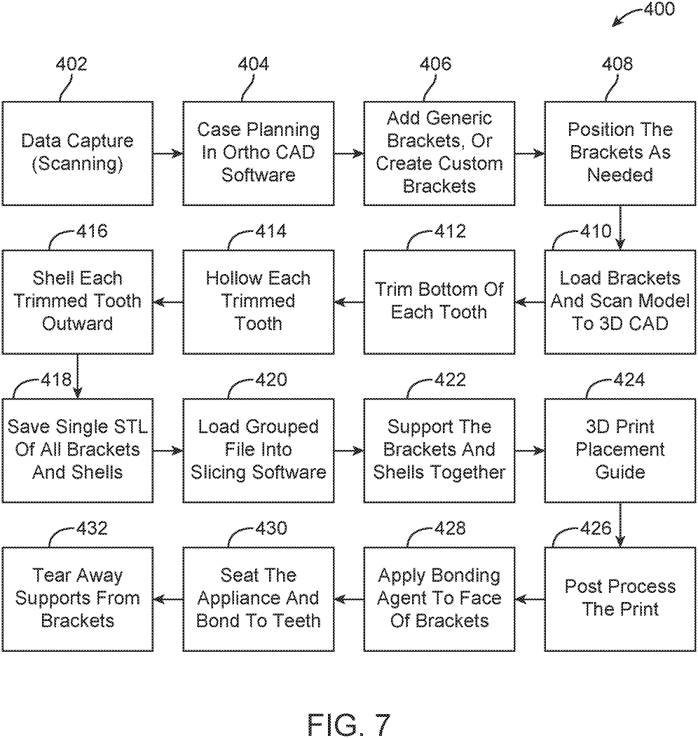

In some embodiments, as shown in FIG. 7, the above workflow may be summarized as actions 400 as described below.

402: Data capture (scanning) of the patient’s teeth impression.

404: Case planning (treatment planning) using orthodontic CAD software.

406: Add CAD files for the bracket members 102 (generic and/or custom) to the orthodontic CAD software.

408: Position the modeled bracket members 102 in the software as needed.

410: Load bracket member 102 CAD files and the patient’s scan model into CAD software;

412: Trim (isolate) bottom portion of each desired tooth T.

414: Hollow each trimmed bottom portion.

416: Shell each trimmed bottom portion to create a shell member 204 with sidewalls 206 of desired thickness.

418: Combine the bracket members 102 CAD file and the shell members 204 CAD file into a single CAD file.

420: Load combined file into 3D printing software (slicing software).

422: Add the support members 304, the support beams 308, and/or the base(s) 302 (automatically and/or manually within the software) to form the overall system 10.

424: 3D print the system 10.

426: Post process the printed system 10.

428: Apply bonding agent to the back sides 114 of the bracket members 102.

430: Seat the system 10 to the patient’s teeth and allow the bond to cure.

432: Remove support members 304 from the bracket members 102 leaving only the bracket members 102 bonded to the patient’s teeth T.

It is understood that the actions 400 described above are meant for demonstration and that additional actions also may be taken. In addition, not all actions 400 may be taken and/or the actions 400 may be taken in different order(s). As such, the actions 400 are illustrative steps and are not meant to limit the scope of the present invention in any way.

It is understood that any aspect or element of any embodiment described herein or otherwise may be combined with any other aspect or element of any other embodiment to form additional embodiments of the system 10, all of which are within the scope of the system 10.

Where a process is described herein, those of ordinary skill in the art will appreciate that the process may operate without any user intervention. In another embodiment, the process includes some human intervention (e.g., a step is performed by or with the assistance of a human).

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs,” and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only,” the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and / or identify, and not to show any serial or numerical limitation or ordering.

No ordering is implied by any of the labeled boxes in any of the flow diagrams unless specifically shown and stated. When disconnected boxes are shown in a diagram, the activities associated with those boxes may be performed in any order, including fully or partially in parallel.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of manufacturing an orthodontic bracket system, the method comprising:
(A) receiving, by one or more computer systems, a digital impression of a patient’s tooth;
(B) receiving, by the one or more computer systems, a digital model of an orthodontic bracket;
(C) positioning, by the one or more computer systems, the digital model of the orthodontic bracket onto the digital impression of the patient’s tooth;
(D) forming, by the one or more computer systems, a digital model of a placement member including at least one support contour that matches at least one contour of the digital model of the patient’s tooth;
(E) placing, by the one or more computer systems, the at least one support contour of the placement member digital model onto the at least one matching contour of the digital impression of the patient’s tooth;
(F) forming, by the one or more computer systems, a digital model of a base member;
(G) forming, by the one or more computer systems, a digital model of a support member, the digital model of the support member extending between the digital model of the base member and the digital model of the orthodontic bracket and/or between the digital model of the base member and the digital model of the placement member; and
(H) printing, using a three-dimensional printer, the digital model of the orthodontic bracket, the digital model of the placement member, the digital model of the base member, and the digital model of the support member to form a physical orthodontic bracket system, wherein the physical orthodontic bracket system includes an orthodontic bracket, a placement member, a base member, and a support member as a single unit.

2. The method of manufacturing of claim 1 wherein the printing of the digital model of the orthodontic bracket, the digital model of the placement member, the digital model of the base member, and the digital model of the support member includes combining the digital model of the orthodontic bracket, the digital model of the placement member, the digital model of the base member, and the digital model of the support member into a single printable file.

3. The method of manufacturing of claim 1 wherein the forming of the digital model of the placement member in (D) further comprises:
(D)(1) forming a digital shell, by the one or more computer systems.

4. The method of manufacturing of claim 3, wherein forming a digital shell in (D)(1) further comprises:
(D)(2) isolating, by the one or more computer systems, a lower portion of the digital impression of the patient’s tooth;
(D)(3) hollowing, by the one or more computer systems, the isolated lower portion of the digital impression of the patient’s tooth to form the digital shell.

5. The method of manufacturing of claim 4, further comprising:
(D)(3) forming, by the one or more computer systems, sidewalls of a desired thickness of the digital shell.

6. The method of manufacturing of claim 3, wherein an inner surface of the digital shell includes the at least one support contour.

7. The method of manufacturing of claim 3, wherein the placing of the at least one support contour of the placement member digital model onto the at least one matching contour of the digital impression of the patient’s tooth in (E) includes placing the digital shell onto the lower portion of the digital impression of the patient’s tooth.

8. The method of manufacturing of claim 1 further comprising:
(I) applying a bonding agent to a back side of the orthodontic bracket;
(J) placing the placement member onto the patient’s tooth;
wherein placing the placement member onto the patient’s tooth places the back side of the orthodontic bracket onto a front surface of the patient’s tooth.

9. The method of manufacturing of claim 8, further comprising:
(K) disconnecting the support member from the orthodontic bracket.

10. An orthodontic bracket system comprising:
a bracket member adapted to be coupled to a surface of a tooth and to receive a tooth straightening mechanism;
a placement member adapted to contact at least one surface of the tooth;
a base member;
a support member configured between the base member and the bracket member and/or between the base member and the placement member.

11. The orthodontic bracket system of claim 10 wherein the placement member includes a shell including an inner volume adapted to receive a bottom portion of the tooth.

12. The orthodontic bracket system of claim 11 wherein the shell inner volume is defined by inner sidewalls and wherein the inner sidewalls include at least one inner sidewall contour that matches a contour of the at least one surface of the tooth.

13. The orthodontic bracket system of claim 10 wherein the support member includes at least one elongate post.

14. The orthodontic bracket system of claim 13 wherein the at least one elongate post includes a tapered distal tip.

15. The orthodontic bracket system of claim 14 wherein the tapered distal tip is at an offset angle with respect to the at least one elongate post.

16. The orthodontic bracket system of claim 10 wherein the base member is located below the bracket member and/or below the placement member.

17. The orthodontic bracket system of claim 10 wherein the tooth straightening mechanism includes an archwire.
